(19) United States
(12) Patent Application Publication
(10) Pub. No.: US 2013/0318238 A1
(43) Pub. Date: Nov. 28, 2013

(54) SAMPLING NETWORK TRAFFIC

(71) Applicants: Matthew Richard Thomas Hall, Santa Clara, CA (US); Reinoud Jelmer Jeroen Koornstra, Roseville, CA (US); Kevin M. Worth, Roseville, CA (US)

(72) Inventors: Matthew Richard Thomas Hall, Santa Clara, CA (US); Reinoud Jelmer Jeroen Koornstra, Roseville, CA (US); Kevin M. Worth, Roseville, CA (US)

(73) Assignee: HEWLETT-PACKARD DEVELOPEMENT COMPANY

(21) Appl. No.: 13/984,336

(22) PCT Filed: Mar. 11, 2011
(86) PCT No.: PCT/US11/28043

§ 371 Date: Aug. 8, 2013

(51) Int. Cl. H04L 12/26

(52) U.S. Cl. CPC H04L 43/04
USPC 709/224

(57) ABSTRACT

Sampling network traffic includes: loading a packet sampling module into a processor-based network device coupled to a network; determining with the packet sampling module if a network packet addressed to or from the network device is selected for sampling; and transmitting data from the network packet over the network to a monitoring device external to the network device if the network packet is selected for sampling.

### BACKGROUND

Organizations continue to rely on networks of interconnected devices to exchange information and provide services. Accordingly, the size of many computer networks continues to grow, along with the amount of data exchanged over the networks. With this growth come increased threats to network security and network efficiency. These threats may include malicious network traffic designed to exploit vulnerabilities in network devices to compromise network security and unnecessary or unwanted network traffic that consumes resources and degrades network performance.

To detect such threats and manage network traffic flow generally, a network may utilize network traffic sampling to obtain a view of the overall health of the network. One popular method of network traffic sampling involves the installation of specialized packet sampling software on switches used by the network to deliver packets. This software samples network packets passing through the switches en route to their destinations and transmits a portion of each sampled network packet to a monitoring appliance. However, this method of sampling network traffic has its drawbacks. For example, the network switches used by the network must be capable of supporting the packet sampling software to employ sampling. Additionally, sampling packets at the switches provides no visibility into encrypted packets or traffic exchanged between virtual machines implemented by the same virtual host.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a block diagram of an illustrative network device, according to one example of principles described herein.

FIGS. 2A, 2B, and 2C are block diagrams of network traffic sampling in an illustrative network, according to various examples of principles described herein.

FIG. 3 is a block diagram of an illustrative network system, according to one example of principles described herein.

FIGS. 4A, 4B, and 4C are diagrams of illustrative sample reporting packets derived from sampled packets, according to one example of principles described herein.

FIG. 5 is a flowchart diagram of an illustrative method of sampling network traffic, according to one example of principles described herein.

FIG. 6 is a flowchart diagram of an illustrative analyzing network traffic sampled by loadable kernel modules in multiple network devices, according to one example of principles described herein.

FIGS. 7A and 7B are flowchart diagrams illustrative methods of analyzing network traffic sampled by loadable kernel modules in multiple network devices, according to examples of principles described herein.

FIG. 8 is a flowchart diagram of an illustrative method of analyzing network traffic sampled by loadable kernel modules in multiple network devices, according to one example of principles described herein.

Throughout the drawings, identical reference numbers designate similar, but not necessarily identical, elements.

### DETAILED DESCRIPTION

The present specification describes methods, systems, and computer program products which use loadable modules in the source and/or destination of network packets to accomplish network traffic sampling without the need for sampling support from network switches, By conducting network traffic sampling within the kernel of a network device which sends and receives packets on the network, a network administrator can gain visibility into encrypted traffic and traffic within virtualized environments that would not otherwise be visible through switch-based sampling.

In particular, the present specification describes a method of sampling network traffic in an operating system kernel that includes: loading a packet sampling module into a processor-based network device coupled to a network; determining with the packet sampling module if a network packet addressed to or from the network device is selected for sampling: and transmitting data from the network packet aver the network to a monitoring device external to the network device if the network packet is selected for sampling.

Additionally, the present specification describes a method of sampling network traffic that includes: selecting a number of processor-based devices in a network for packet sampling; loading a packet sampling module into an operating system kernel for each selected network device; receiving data contained in sampled network packets from the packet sampling modules over the network; and compiling the data to determine a health of the network.

The present specification also describes a network device which includes a processor communicatively coupled to a memory. The processor executes operating system kernel code stored on the memory, which causes the processor to: determine in the operating system kernel if a network packet addressed to or from the network device is selected for sampling; and transmit data from the network packet over a network to a monitoring device external to the network device if the network packet is selected for sampling

As used in the present specification and in the appended claims, the word “packet” means a block of data formatted for transmission to an addressable entity over a network.

As used in the present specification and in the appended claims, the word “kernel” means a central component of an operating system which controls access to hardware resources associated with a processor executing the operating system.

As used in the present specification and in the appended claims, the word “external,” when describing a computer-implemented machine or device, refers to a machine or device that is implemented by a physically distinct processor. For example, a security device that is external to a virtualized host is implemented by a processor that is physically distinct from the processor(s) used to implement the virtualized host.

As used in the present specification and in the appended claims, the word “processor” refers to a hardware apparatus capable of executing code. A processor may include multiple central processing units.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with the example is included in at least that one example, but not necessarily in other examples. The various instances of the phrase “in one example” or similar phrases in various places in the specification are not necessarily all referring to the same example.

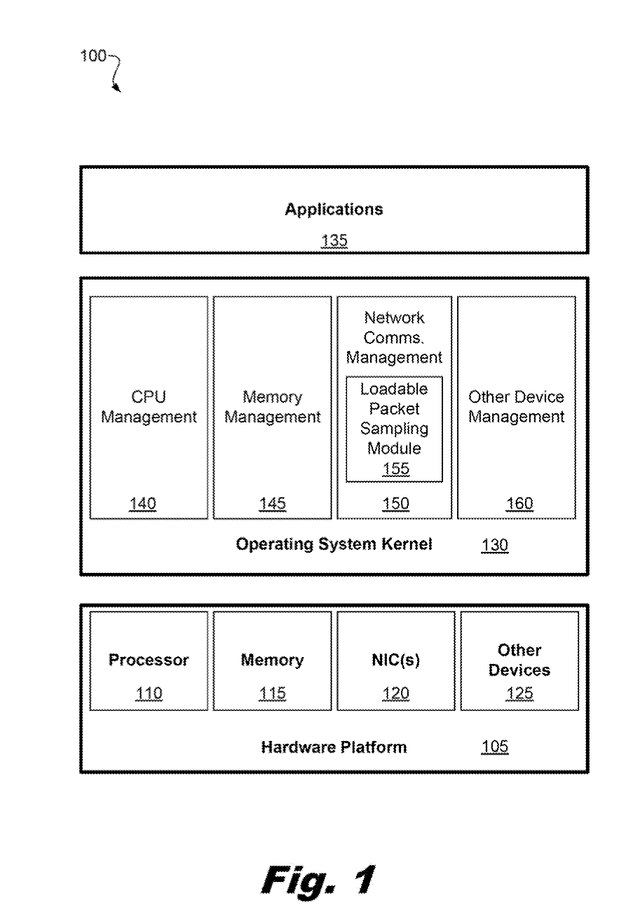

Referring now to the Figures, FIG. 1 shows a block diagram of an illustrative network device (100) which may send and receive data over a network. The illustrative network device (100) may implement, for example, an addressable device on a computer network, such as a server device or a client computer. The illustrative network device (100) includes a hardware platform (105) made up of at least one processor (110), computer memory (115), a network interface card (NIC) (120), and other hardware devices (125). A motherboard may interconnect some or all of the hardware platform devices. The other hardware devices (125) may include, but are not limited to, peripheral input/output devices, storage devices, and any other hardware devices that may be suitable for a particular application of the principles described in the present specification.

The processor (110) executes code stored by the main memory (115). In certain examples, the processor (110) may include at least one multi-core processor having multiple independent central processing units (CPUs), with each CPU having its own L1 cache and all CPUs sharing a common bus interface and L2 cache. Additionally or alternatively, the processor (110) may include at least one single-core processor.

The main memory (115) stores code which is executed by the processor (110) to implement an operating system kernel (130). The operating system kernel (130) initializes and manages the devices of the hardware platform (105), and serves as a bridge between the hardware platform (105) and higher-level applications (135).

As shown, the operating system kernel (130) may include modules for CPU management (140). memory management (145), network communications management (150), and other device management (160). The operating system kernel (130) may also be extensible through the use of one or more loadable kernel modules. A loadable kernel module is an object file that contains code to extend the functionality of the base operating system kernel (130). Functionality may be added to the operating system kernel (130) by selectively activating a loadable kernel module implementing the desired functionality to be added. Similarly, functionality may be removed from the operating system kernel (130) by selectively deactivating or removing a loadable kernel module from the operating system kernel (130).

Thee loadable packet sampling module (155) in the operating system kernel (130) of FIG. 1 is one such loadable kernel module. The loadable packet sampling module (155) causes packet monitoring and sampling operations to be performed from within the operating system kernel (130) of a host device or client device on the network. The use of a loadable kernel module in host and client devices on the network to perform packet monitoring and sampling provides a number of benefits over traditional approaches which employ packet sampling in network switches.

One of the benefits associated with the use of a loadable packet sampling kernel module (155) in addressed network devices (100) is the fact that the loadable packet sampling kernel module (155) can be customized to the network device (100). For example, it may be desirable to sample more packets from the network traffic through a first network device and fewer packets from the network traffic passing through a second network device. In this case, the loadable packet sampling kernel module (155) for the first network device can be customized to perform select more network packets for sampling while the loadable packet sampling kernel module (155) for the second network device can be customized to select fewer packets for sampling. This added degree of flexibility in monitoring and sampling network traffic may allow for the most efficient and beneficial use of processing resources in an external network monitoring appliance.

Another benefit associated with the use of a loadable packet sampling kernel module (155) in network devices (100) is the ability to gain visibility into traffic passing between virtual machines in a virtualized environment. For example, in traditional systems where packet sampling occurs at network switches, it may be difficult to sample packets transmitted between two virtual machines hosted by the same host device, as this traffic may never pass through a physical network switch. By contrast, in the present system packet sampling occurs within the operating system kernel (130) of the host device itself, thereby enabling the examination and sampling of network traffic between the virtual machines.

Yet another benefit associated with the use of a loadable packet sampling kernel module (155) in network devices (100) is the ability to selectively activate and deactivate the packet monitoring and sampling functionality in real-time without interrupting the flow of network traffic. Loadable kernel modules may be loaded to and removed from the operating system kernel (130) while the operating system kernel (130) is running and without disrupting system operations. In this way, network traffic monitoring and sampling may be selectively activated or deactivated for each network device (100) for which a loadable packet sampling kernel module is available. Network traffic monitoring and sampling may be dynamically switched in on or off in one or more machines to conserve processing resources in specific devices and/or to focus network monitoring and sampling operations on one or more specific devices. Alternatively, the sampling function in a loadable packet sampling kernel module may be selectively disabled or enabled in real time without removing the kernel module from the kernel.

Still another benefit associated with the use of a loadable packet sampling kernel module (155) in a network device (100) is that of security. The operating system kernel (130) is typically very secure and less likely to fall prey to attacks from foreign applications or processes. Thus, it is less likely that an external process or malicious user without root access would be able to compromise packet monitoring and sampling operations in the network device (100).

Many of the same benefits described above with respect to a loadable packet sampling kernel module may also be achieved using a userspace sampling dameon, driver, or other machine-readable instructions that run within an application server and/or above a microkernel. While for the sake of clarity the present specification primarily describes examples using loadable packet sampling kernel modules to sample packets in a device that is the originator or final recipient of network packets, it should be understood that many of these principles may also be applied to userspace sampling daemons, drivers, or other machine-readable instructions running within an application server and/or above a microkernel.

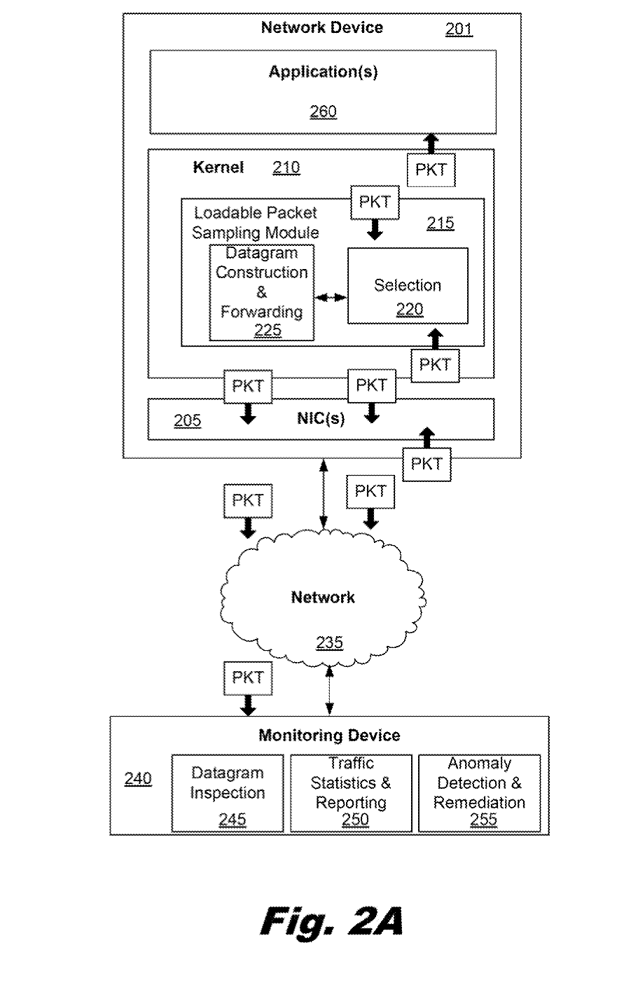

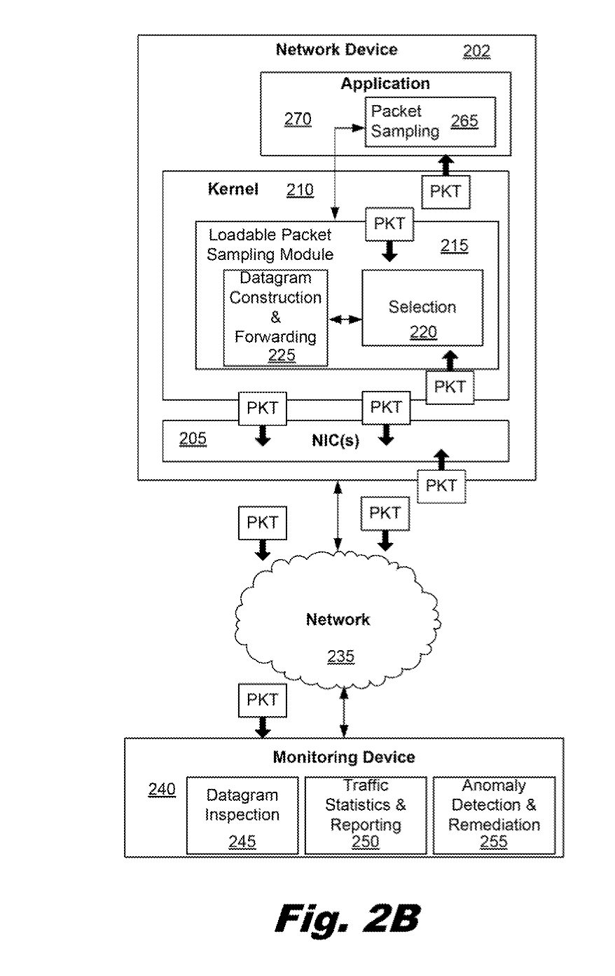

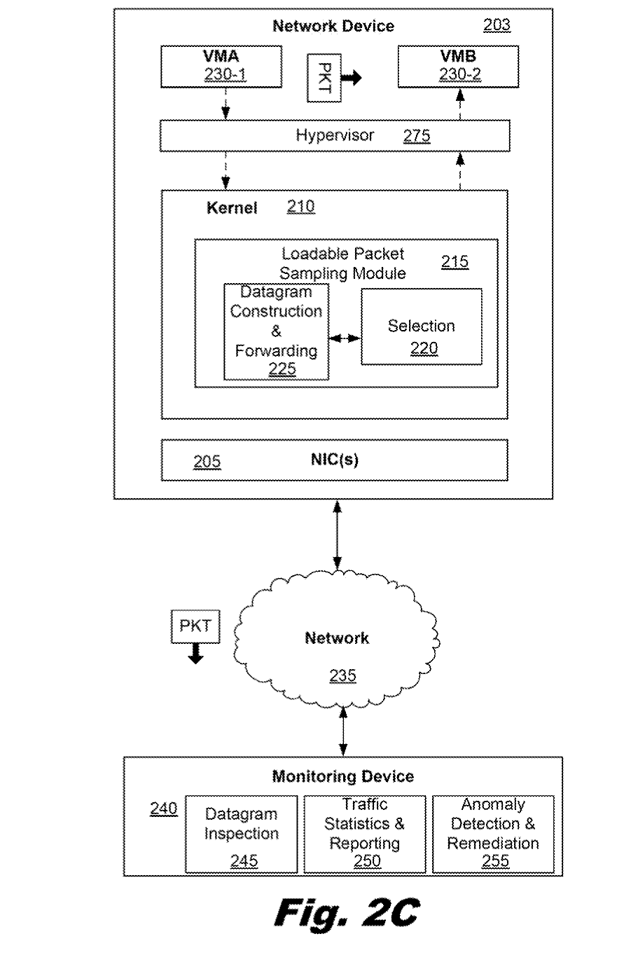

FIGS. 2A-2C show block diagrams of network traffic sampling in network devices using loadable packet sampling modules according various examples of the principles of the present specification, In each of FIGS. 2A-2C, a network device (201, 202, 203, respectively) includes one or more network interface controllers (NICs) (205) and an operating system kernel (210). Other elements of the network device (201, 202, 203), including the hardware platform and various elements of the operating system and operating system kernel (210) are omitted in FIGS. 2A-2C for clarity. The operating system kernel (210) for each network device (201, 202, 203) includes a loadable packet sampling module (215), consistent with the explanation given above with reference to FIG. 1.

The loadable packet sampling module (215) includes a selection submodule (220) and a datagram construction and forwarding submodule (225). Of course, while the functionality of the loadable packet sampling module (215) is shown in these figures using two submodules (220, 225), this same functionality may be divided up into more or fewer submodules as may suit a particular application of the principles described herein.

The selection submodule (220) monitors network packets (PKT) passing through the network device (201, 202, 203) and determines whether each packet is selected for sampling. These network packets may be packets sent by the network device (202) over a network (235), received by the network device (202) from the network (235), and/or packets to or from virtual machines (230-1, 230-2, FIG. 2C) hosted by the network device (201, 202, 203). The selection process may be based on a formula used to sample an average of every n packets passing through the network device (201, 202, 203). If the packet is selected for sampling, the datagram construction and forwarding submodule (225) creates a datagram containing data from the sampled packet and sampling statistics for the network device (201, 202, 203), and forwards the datagram in a packet over the network (235) to an external monitoring device (240).

The external monitoring device (240) of the present example is a processor-based network apparatus that includes a datagram inspection module (245), a traffic statistics and reporting module (250), and an anomaly detection and remediation module (255). For each packet received by the external monitoring device (240) from a loadable packet sampling module (215), the datagram inspection module (245) retrieves the sampled packet data and sampling statistics from the application-layer datagram.

The traffic statistics and reporting module (250) updates compiled traffic statistics for the network (235) and makes the statistics available to a network administrator or other authorized entity. The traffic statistics and reporting module (250) may report the statistics as raw data and/or in a summarized form. Additionally or alternatively, the traffic statistics and reporting module (250) may make conclusions regarding the health of the network (235) from the compiled traffic statistics and provide an indication of network health based on the compiled traffic statistics.

The anomaly detection and remediation module (255) may examine the compiled traffic statistics and/or data from individual sampled packets to detect anomalies. Examples of such anomalies include network security issues or events (e.g., software vulnerability exploitations, malware, resource attacks, traffic to or from prohibited entities), overly burdened network devices, network errors, unusual or unexpected network traffic characteristics, and the like.

In certain examples, the anomaly detection and remediation module (255) may take action to inform a network administrator or other entity of the detected anomaly through an appropriate medium (e.g., alarm, email, textual message, etc.). Additionally or alternatively, the anomaly detection and remediation module (255) may take automatic action to directly remediate or alleviate the anomaly. For example, if the monitoring device (240) determines from the compiled traffic statistics that a certain network device (201, 202, 203) is overburdened with traffic, the monitoring device (240) may take steps to divert some of the network traffic from the overburdened network device (201, 202, 203) to an underutilized network device (201, 202, 203), In another example, if traffic from a prohibited entity is detected on the network (235), the network monitoring device (240) may adjust routing tables in network routers to foreclose the prohibited traffic.

In alternate examples, some or all of the functionality of the network monitoring device (240) may be performed within the network device (201) itself. The network device (201) may have processing resources which are allocable to the inspection and analysis of packets selected by the loadable packet sampling module (215). Thus, in some examples the network device (201) may inspect the sampled packets, gather traffic statistics for the network device, and detect and remediate anomalies from the traffic statistics without the aid of an external monitoring device (240). Alternately, the network device (201) may perform some inspection and analysis of packets sent from and received by the network device and forward only some of the sampled packets to the external monitoring device (240) for use in gathering traffic statistics and detecting anomalies in the network as a whole.

FIGS. 2A, 2B, and 2C illustrate the functionality of the loadable packet sampling module (215) and the monitoring device (240) in different contexts. In FIG. 2A, the loadable packet sampling module (215) samples packets as the packets pass through the network device (201) between the network (235) and one or more applications (260) executed by the network device (201).

In FIG. 2B, the loadable packet sampling module (215) works in conjunction with a packet sampling module (265) in an application (270) implemented by the network device (202) in order to sample and report application-level data. This approach may prove particularly useful in the monitoring of encrypted application-level data. Under one potential scenario, the selection module (220) of the loadable packet sampling module (215) may select an encrypted packet addressed to the application (270) for sampling and indicate the selection to the packet sampling module (265) of the application (270). When the application (270) receives and decrypts the data from the selected packet, the packet sampling module (265) of the application (270) may provide at least a portion of the decrypted data from the selected packet to the loadable packet sampling module (215), which includes the decrypted data in the datagram sent to the monitoring device (240) for the selected packet.

Thus, where prior approaches to network traffic sampling are unable to effectively sample encrypted application-level data from network packets, the present system provides an efficient solution to sampling this type of high-level data. This ability can prove invaluable to network security, as the monitoring device (240) may be able to detect and remediate against malware or other problematic data transmitted to a network device (202). Additionally, the monitoring device (240) may be able to compile a more accurate and complete view of network health (235) and traffic trends by including a view of application-level data in its analysis.

In FIG. 2C, the network device (203) is a virtualized host which executes a hypervisor (275) to implementing multiple virtual machines (230-1, 230-2). These virtual machines (230-1, 230-2) may transmit data to each other using a virtualized network switch implemented by the hypervisor (275), The loadable packet sampling module (215) may communicate with the hypervisor (275) to select certain packets transmitted between the virtual machines (230-1, 230-2) for sampling. In this way, even data from traffic between virtual machines that would ordinarily never go beyond the hypervisor (275) may be transmitted to the monitoring device (240) for inspection and reporting.

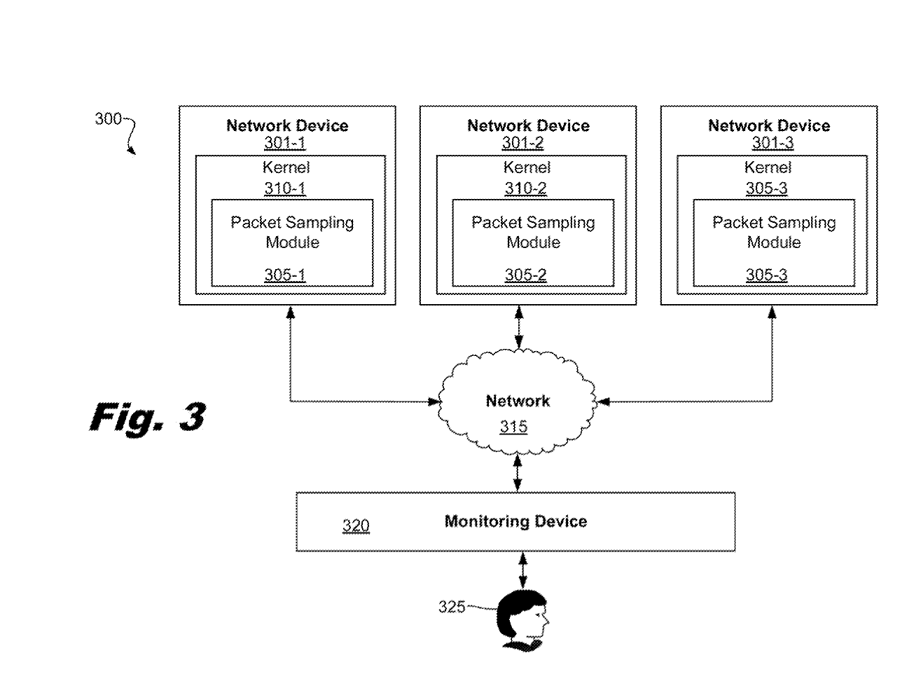

FIG. 3 is a block diagram of an illustrative system (300) including multiple network devices (301-1 to 301-3) having respective loadable packet sampling modules (305-1 to 305-3) in their respective operating system kernels (310-1 to 310-3), Each of the network devices (301-1 to 301-3) is communicatively coupled to a network (315). Each of the loadable packet sampling modules (305-1 to 305-3) samples packets passing through its respective network device (301-1 to 301-3) and transmits data from sampled packets together with sampling statistics to a monitoring device (320) over the network (315), consistent with the details described previously.

Because the monitoring device (320) can receive sampled network traffic data from each of the network devices (301-1 to 301-3) on the network (315), the monitoring device (320) may compile network traffic statistics for the entire system (300). However, another feature of this example is the fact that the loadable packet sampling modules (305-1 to 305-3) may be selectively loaded to or removed from their respective operating system kernels (310-1 to 310-2, 310-3) in real-time without rebooting their respective network devices (301-1 to 301-3). In alternative examples, the loadable packet sampling modules (305-1 to 305-3) may continuously run in the kernel and the sampling functionality of the kernels may be selectively enabled or disabled.

Thus, if one or more network devices (301-1 to 301-3) become overburdened, the packet sampling module (305-1 to 305-3) for that network device (301-1 to 301-3) may be removed to free up computing resources. Additionally, if the monitoring device (320) or a network administrator (325) elects to sample network traffic from only a subset of network devices (301-1 to 301-3), the packet sampling modules (305-1 to 305-3) for those network devices (301-1 to 301-3) not in the subset may be removed.

Conversely, if the monitoring device (320) of the network administrator (325) chooses to begin or resume sampling traffic from a particular network device (301-1 to 301-3), the packet sampling module (305-1 to 305-3) for that network device (301-1 to 301-3) may be loaded and reactivated.

The selective loading or removing of the packet sampling modules (305-1 to 305-3) in network devices (301-1 to 301-3) may in some examples occur by way of a command from the monitoring device (320) or another administrative device connected to the network (315). This command may occur as a result of dynamic decisions automatically made by the monitoring device (320) or another administrative device to enforce network policy.

Additionally or alternatively, the administrator (325) may manually load and remove the packet sampling modules (305-1 to 305-3) in the network devices (301-1 to 301-3) directly, using the monitoring device (320), or by taking other administrative action that may better suit a specific application of the principles described herein.

Additionally or alternatively, the network devices (301-1 to 301-3) themselves may be configured to automatically load and remove the packet sampling modules (305-1 to 305-3) from their respective operating system kernels (310-1 to 310-3) based on detected events, conditions or triggers. For example. if a network device (301-1) detects a utilization of processor resources beyond a predefined threshold, the network device (301-1) may automatically remove the packet sampling module (305-1) to free up processing resources. Conversely, if the network device (301-1) detects that resource utilization drops below a certain threshold, the network device (301-1) may automatically reload the packet sampling module (305-1) into its operating system kernel (310-1),

In the same way that the loadable packet sampling modules (305-1 to 305-3) may be selectively loaded and removed from their respective kernels (310-1 to 310-3), the sampling parameters of the packet sampling modules (305-1 to 305-3) may be dynamically updated as may suit a particular situation or network policy. For example, it may be desirable to sample more packets from a subset of the network devices (301-1 to 301-3) and fewer packets from the remaining network devices (301-1 to 301-3). In this case, the sampling parameters of the packet sampling modules (305-1 to 305-3) in the selected network devices (301-1 to 301-3) may be automatically updated by an administrative device on the network, by the devices (301-1 to 301-3), or manually by an administrator (325) to increase the number of packets selected for sampling. Likewise, the sampling parameters of the network devices (301-1 to 301-3) not in the selected subset may remain the same or be updated to decrease the number of packets selected for sampling.

Similarly, in some examples the sampling functionality of the loadable packet sampling modules (305-1 to 305-3) may be selectively disabled without removing the loadable packet sampling modules (305-1 to 305-3) from their respective kernels (310-1 to 310-3). In this way, packet sampling effectuated by the operating system kernels (310-1 to 310-3) may be turned on and off through a simple application programming interface (API) call to the kernel without expending the processing resources to load and remove the modules (305-1 to 305-3) whenever sampling functionality is desired.

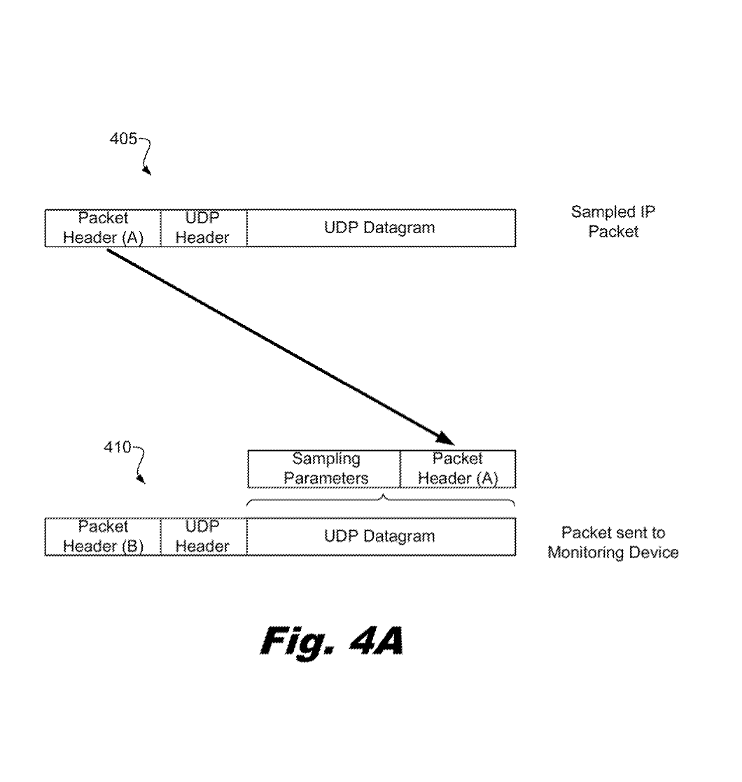

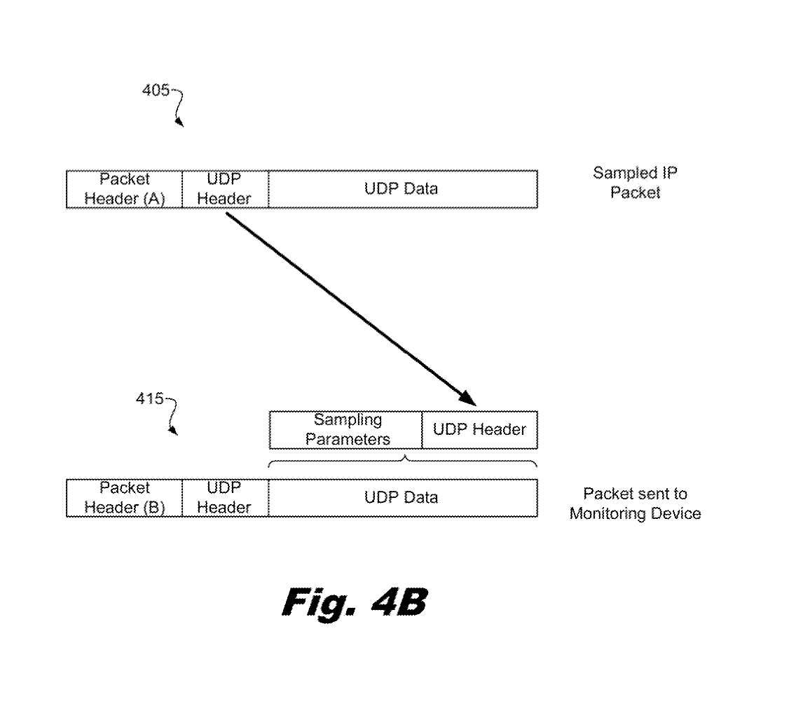

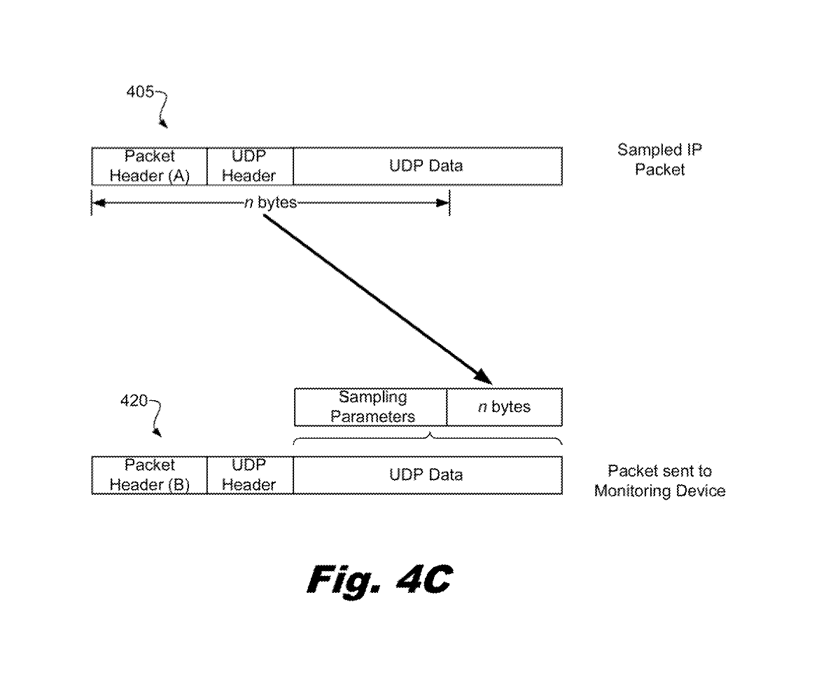

FIGS. 4A-4C show various examples of the composition of sampling packets sent to a monitoring device from a loadable packet sampling kernel module according to the principles described above. In each of FIGS. 4A-4C, a network-layer Internet Protocol (IP) packet (405) is sampled by the packet sampling kernel module, and an IP packet (410, 415, 420) is sent to the monitoring device with sampling parameters and data from the sampled IP packet (405). Each IP packet (405, 410, 415, 420) includes an IP Packet. Header for delivery to an IP address, a User Datagram Protocol (UDP) header with application-layer delivery information, and a UDP datagram containing the application-layer payload data. It will be understood that while the examples of FIGS. 4A-4C show IP type packets, any type of packet may be sampled according to the principles described herein. Examples of packets that may be sampled using the principles described herein include, but are not limited to Transmission Control Protocol (TCP) packets, Internet Control Message Protocol (ICMP) packets, Address Resolution Protocol (ARP) packets, and the like,

In the example of FIG. 4A, the UDP datagram of the IP packet (410) sent to the monitoring device includes sampling parameters from the loadable packet sampling kernel module and the IP Packet Header from the sampled IP packet (405). In the example of FIG. 4B, the UDP datagram of the IP packet (415) sent to the monitoring device includes sampling parameters and the UDP header from the sampled IP packet (405). In the example of FIG. 4C, the UPD datagram of the IP packet (420) sent to the monitoring device includes sampling parameters and a specified number (n) of bytes from the sampled IP packet (405). Of course, any other arrangement of data may be used in the packet sent to the monitoring device. For example, some or all of the packets sent to the monitoring device may omit the sampling parameters. Additionally or alternatively, the UDP datagram of the IP packet sent to the monitoring device may include the entire sampled IP packet (405) or the entire UDP datagram of the sampled IP packet (405). Any suitable data arrangement may be used to report data from a sampled packet and/or sampling parameters to a monitoring device, as may best suit a particular application of the principles described herein.

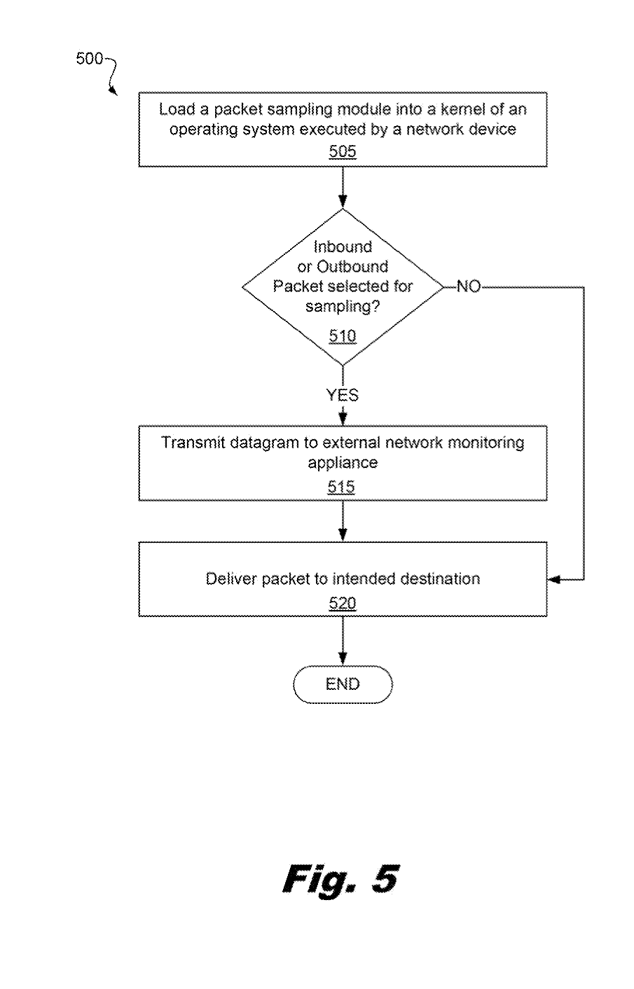

FIG. 5 is a flowchart diagram of an illustrative method (500) of sampling network traffic. According to the method (500), a packet sampling module is loaded (block 505) into a kernel of an operating system executed by a processor-based network device. In certain examples, the packet sampling module may be loaded into the kernel of the network device while the kernel is running. A determination is then made (block 510) by the packet sampling module as to whether a packet received or transmitted by the network device is selected for sampling. This determination may be made using, for example, a pseudo-random formula which results in an average selection of a certain percentage or ratio of the total packets transmitted through the network device.

If the packet is selected for sampling (block 510, YES), data from the selected network packet is transmitted (block 515) over a network to a monitoring device external to the network device. The packet is directed (block 525) or delivered to its intended destination.

In certain examples, the method (500) may further include loading a second packet sampling module in an application executed by the network device. In these examples, the second packet sampling module may cooperate with the kernel packet sampling module to sample application-layer data (e.g., encrypted application data) as described above.

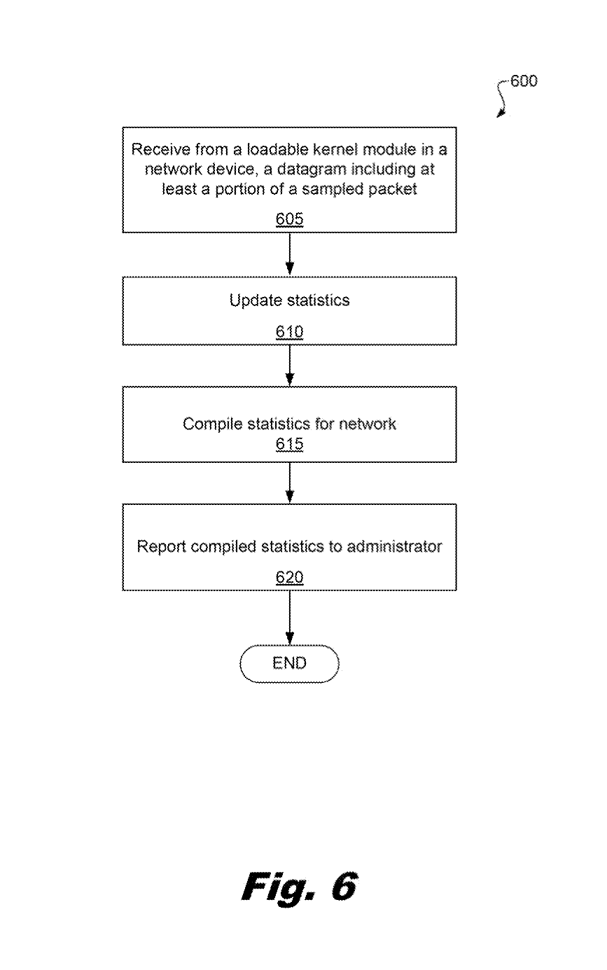

FIG. 6 is a flowchart diagram of an illustrative method (600) of sampling network traffic which may be performed by an external monitoring device. In this method (600), the external monitoring device receives (block 605) from loadable kernel module in a network device a datagram including at least a portion of a sampled packet. The external monitoring device uses the data from the datagram to update (block 610) statistics for the network, compiles the statistics for the network (block 615), and reports (block 620) the compiled statistics to an administrator of the network.

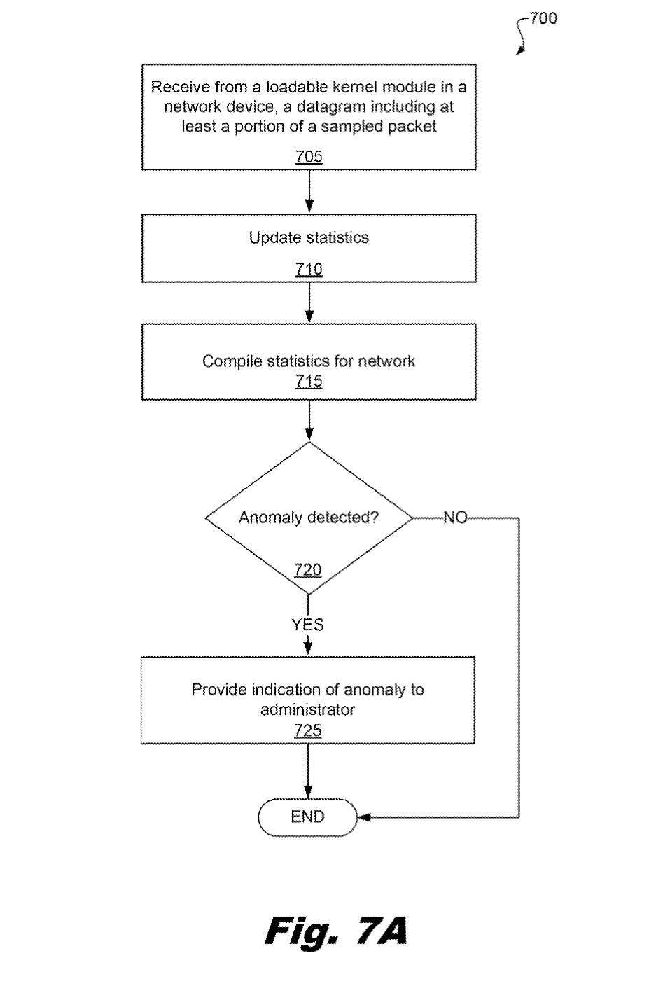

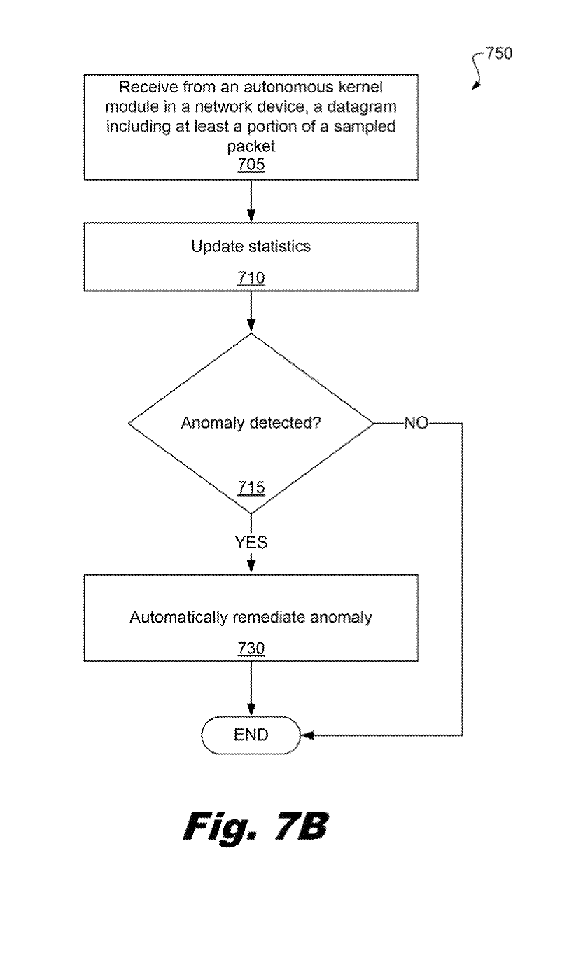

FIGS. 7A and 7B are flowchart diagrams of related illustrative methods (700, 750) of analyzing network traffic sampled by loadable kernel modules in multiple network devices. In each of the methods, the external monitoring device receives (block 705) from loadable kernel module in a network device a datagram including at least a portion of a sampled packet. The external monitoring device uses the data from the datagram to update (block 710) statistics for the network, compiles the statistics for the network (block 715), and then makes a determination (block 720) from the statistics for the network and/or the data from the individual datagram whether an anomaly exists in the network. In the method (700) of FIG. 7A, the external monitoring device provides (block 725) an indication of any anomaly detected to an administrator. An additional or alternative course of action is provided in the method (750) of FIG. 7B, in which the external monitoring device takes action to automatically remediate (block 730) any detected anomaly.

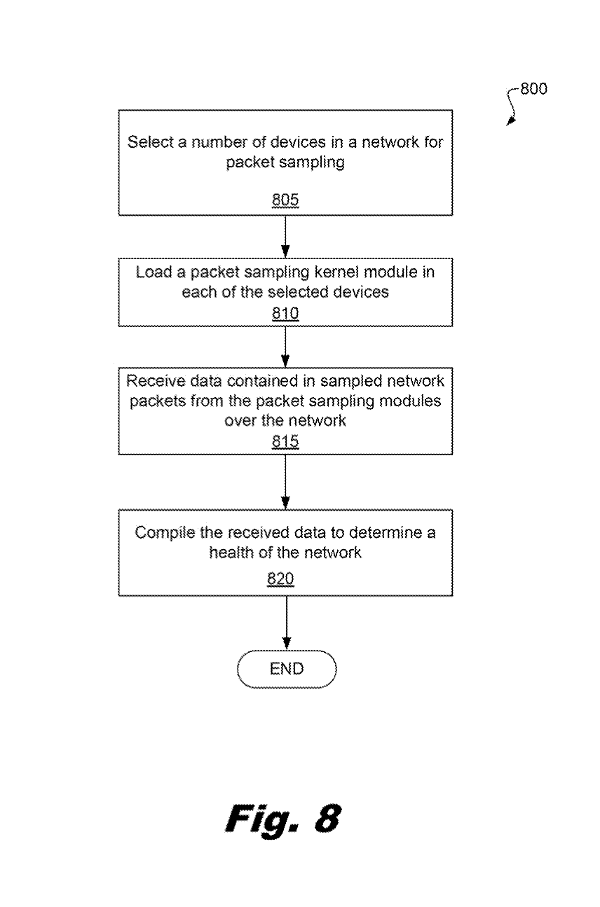

FIG. 8 is a flowchart diagram of another illustrative method (800) of analyzing network traffic sampled by loadable kernel modules in multiple network devices, according to one example of the principles of the present specification. In the method (800) of FIG. 8, a number of processor-based addressable devices in a network is selected (block 805) for packet sampling. For each selected network device, a packet sampling kernel module is loaded (block 810) into the operating system kernel for that device. Data is then received (block 815) from the packet sampling modules over the network and the received data is compiled (block 820) to determine a health of the network. In certain examples, the method (800) may further include determining whether any network device not selected for packet sampling has a loaded sampling kernel module in its operating system kernel, and removing the sampling kernel module from the operating system kernel of any such network device. Additionally, the method may include detecting anomalies in the network from the received data, providing an indication of any detected anomaly to a network administrator, and/or automatically performing a remedial action to correct the anomaly, as described above.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method of sampling network traffic, comprising:
loading a packet sampling module into a processor-based network device coupled to a network;
determining with said packet sampling module if a network packet addressed to or from said network device is selected for sampling; and
transmitting data from said network packet over said network to a monitoring device external to said network device if said network packet is selected for sampling.

2. The method according to claim 1, wherein said packet sampling module is loaded into a kernel of an operating system executed by said processor-based network device.

3. The method according to claim 2, further comprising loading said packet sampling module into said kernel while said kernel is running.

4. The method according to claim 1, wherein transmitting said data from said network packet to said monitoring device comprises transmitting a datagram to said monitoring device, said datagram comprising said data from said network packet and sampling data corresponding to a sampling of said network packet.

5. The method of claim according to claim 1, further comprising loading a second packet sampling module in an application executed by said network device.

6. The method according to claim 5, wherein said data from said network packet comprises application-level data collected by said second packet sampling module in said application,

7. The method according to claim 1, wherein said data from said network packet comprises data decrypted by said network device from an encrypted portion of said network packet.

8. The method according to claim 1, wherein said data from said network packet comprises at least a portion of said network packet.

9. A method, of sampling network traffic, comprising:
selecting a number of processor-based devices in a network for packet sampling;
loading a packet sampling module into an operating system kernel for each selected network device;
receiving data contained in sampled network packets from said packet sampling modules over said network; and
compiling said data to determine a health of said network.

10. The method according to claim 9, further comprising detecting an anomaly in said network from said data.

11. The method according to claim 9, further comprising automatically performing a remedial action to correct said anomaly.

12. The method according to claim 9, further comprising determining whether a said packet sampling kernel module has been loaded into an operating system kernel of a network device not selected for packet sampling.

13. The method according to claim 12, further comprising removing said sampling kernel module from said operating system kernel of said network device not selected for packet sampling.

14. A network device, comprising:
a processor communicatively coupled to a memory, said processor executing operating system kernel code stored on said memory which causes said processor to:
determine in said operating system kernel if a network packet addressed to or from the network device is selected for sampling; and
transmit data from said network packet over a network to a monitoring device external to said network device if said network packet is selected for sampling.

15. The network device according to claim 14, wherein said data from said network packet comprises data decrypted by said network device from an encrypted portion of said network packet.
